(19) United States
(12) Patent Application Publication
(10) Pub. No.: US 2016/0039346 A1
(43) Pub. Date: Feb. 11, 2016

(54) VEHICLE STEP APPARATUS AND EXTENDING AND RETRACTING DEVICE THEREOF

(71) Applicant: T-MAX (HANGZHOU) INDUSTRIAL CO., LTD., Hangzhou (CN)

(72) Inventors: Huizhong Yang, Hangzhou (CN); Zhaobo Qing, Hangzhou (CN); Xinfa Du, Hangzhou (CN)

(21) Appl. No.: 14/540,702

(22) Filed: Nov. 13, 2014

(30) Foreign Application Priority Data
Aug. 11, 2014 (CN) 201410392412.4
Aug. 11, 2014 (CN) 201420450643.1

(51) Int. Cl. B60R 3/00

(52) U.S. Cl. CPC B60R 3/007

(57) ABSTRACT

An extending and retracting device for use with a vehicle step apparatus, including a mounting bracket; a step bracket; a first arm defining a first end pivotally connected to the mounting bracket and a second end pivotally connected to the step bracket; a second arm defining a first end pivotally connected to the mounting bracket and a second end; a third arm defining a first end pivotally connected to the second end of the second arm and a second end pivotally connected to the step bracket; and a fourth arm defining a first end pivotally connected to the second end of the second arm and the first end of the third arm respectively, and a second end pivotally connected to the first arm.

### CROSS-REFERENCE TO RELATED APPLICATION

This application is based upon and claims priority to Chinese Patent Application Nos. 201410392412.4 and 201420450643.1, filed on Aug. 11, 2014.

### BACKGROUND OF THE INVENTION

1. Field of the invention

The present invention relates, generally, to vehicle step apparatuses and, more specifically, to an extending and retracting device of a vehicle step apparatus.

2. Description of the Related Art

Conventional vehicle step apparatuses are typically mounted on a vehicle's chassis under a door and are used to assist a passenger in getting on or off the vehicle. The vehicle step apparatuses in the elated art typically employ a four-link or five-link mechanism. When a door of the vehicle is opened, a step member of the vehicle step apparatus automatically extends out from the chassis of the vehicle so that a passenger can get on or off the vehicle. When the door of the vehicle is closed, the step member automatically retracts upwardly to its original position.

A step bracket of the extending and retracting device with a four-link or five-link mechanism typically has poor structural stiffness, poor reliability, a short stroke, and may not be synchronous and interfere with each other, which may lead to the step apparatus breaking down or otherwise being destroyed.

### SUMMARY OF THE INVENTION

The present invention overcomes the disadvantages in the related art in an extending and retracting device for a vehicle step apparatus. The step bracket of the extending and retracting device is high in structural stiffness, reliability, and applicability, and has a long stroke. The present invention is also directed toward a vehicle step apparatus having such an extending and retracting device. The extending and retracting device for a vehicle step apparatus includes: a mounting bracket; a step bracket; a first arm defining a first end pivotally connected to the mounting bracket, and a second end pivotally connected to the step bracket; a second arm defining a first end pivotally connected to the mounting bracket, and a second end; a third arm defining a first end pivotally connected to the second end of the second arm, and a second end pivotally connected to the step bracket; and a fourth arm defining a first end pivotally connected to the second end of the second arm and the first end of the third arm respectively, and a second end pivotally connected to the first arm.

In this way, the extending and retracting device of the present invention is high in structural stiffness, strength, operation stability, reliability, and applicability, and has a long stroke as well as a long life.

In some embodiments, the second arm is substantially coaxial with the third arm and the first arm is substantially parallel to the second and third arms. Moreover, the second end of the fourth arm may be connected with a middle portion of the first arm. Further, the first to fourth arms may be in a form of a plate.

In some embodiments, the first end of the first arm is connected to the mounting bracket via a first pivot, and the second end of the first arm is connected to the step bracket via a second pivot; the first end of the second arm is connected to the mounting bracket via a third pivot; the second end of the second arm and the first end of the third arm are connected to the first end of the fourth arm via a fourth pivot; the second end of the third arm is connected to the step bracket via a fifth pivot; and the second end of the fourth arm is connected to the first arm via a sixth pivot.

In some embodiments, the second end of the second arm has a U-shaped second arm groove, and the first end of the third arm has a protrusion adapted to be fitted within the second arm groove. The protrusion may include two lugs spaced apart from each other, with the first end of the fourth arm is fitted between the two lugs. The first arm may be provided with a first arm groove, and the second end of the fourth arm may be fitted within the first arm groove. In some embodiments, the step bracket has a bracket groove, and the second end of the first arm and the second end of the third arm are fitted within the bracket groove.

The vehicle step apparatus may include: the extending and retracting device according to embodiments of the present invention; a step member mounted on the step bracket of the extending and retracting device; and a drive device driving at least one of the first and second arms to drive the extending and retracting device to move the step member between an extended position and a retracted position.

### BRIEF DESCRIPTION OF THE DRAWINGS

Other objects, features, and advantages of the present invention will be readily appreciated as the same becomes better understood after reading the subsequent description taken in connection with the accompanying drawing wherein:

FIG. 1 is an exploded perspective view of an extending and retracting device for a vehicle step apparatus according to one embodiment of the present invention.

FIG. 2 is a perspective view of the extending and retracting of FIG. 1 in an extended position.

FIG. 3 is a perspective view of the extending and retracting device of FIGS. 1-2 in a retracted position.

FIG. 4 is an exploded perspective view of an extending and retracting device for a vehicle step apparatus according to one embodiment of the present invention.

FIG. 5 is a perspective view of the vehicle step apparatus of FIG. 4 in an extended position.

FIG. 6 is an alternate perspective view of the vehicle step apparatus of FIG. 5.

FIG. 7 is a perspective view of the vehicle step apparatus of FIG. 4 in a retracted position.

FIG. 8 is an alternate perspective view of the vehicle step apparatus of FIG. 7.

### DETAILED DESCRIPTION OF THE INVENTION

Embodiments of the present invention will be described in detail and examples of the embodiments will be illustrated in the drawings, where same or similar reference numerals are used to indicate same or similar members or members with same or similar functions. The embodiments described herein with reference to drawings are explanatory, which are used to illustrate the present invention, but shall not be construed to limit the present invention.

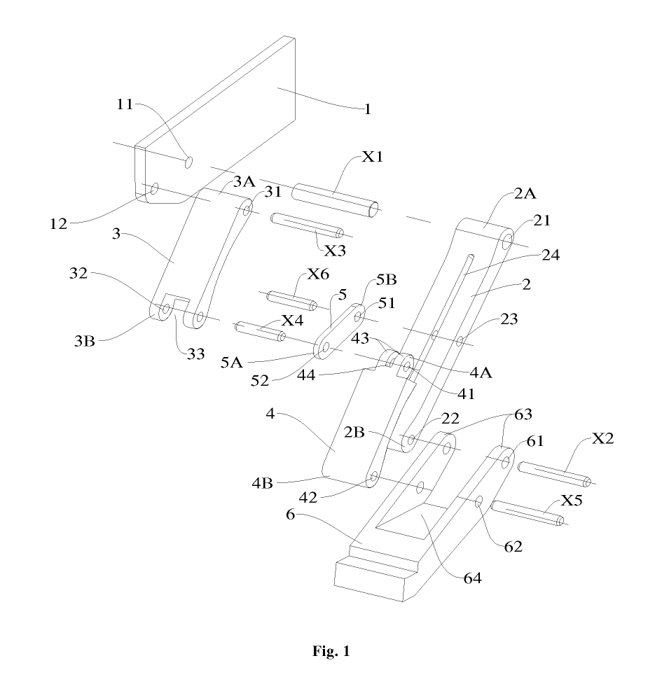

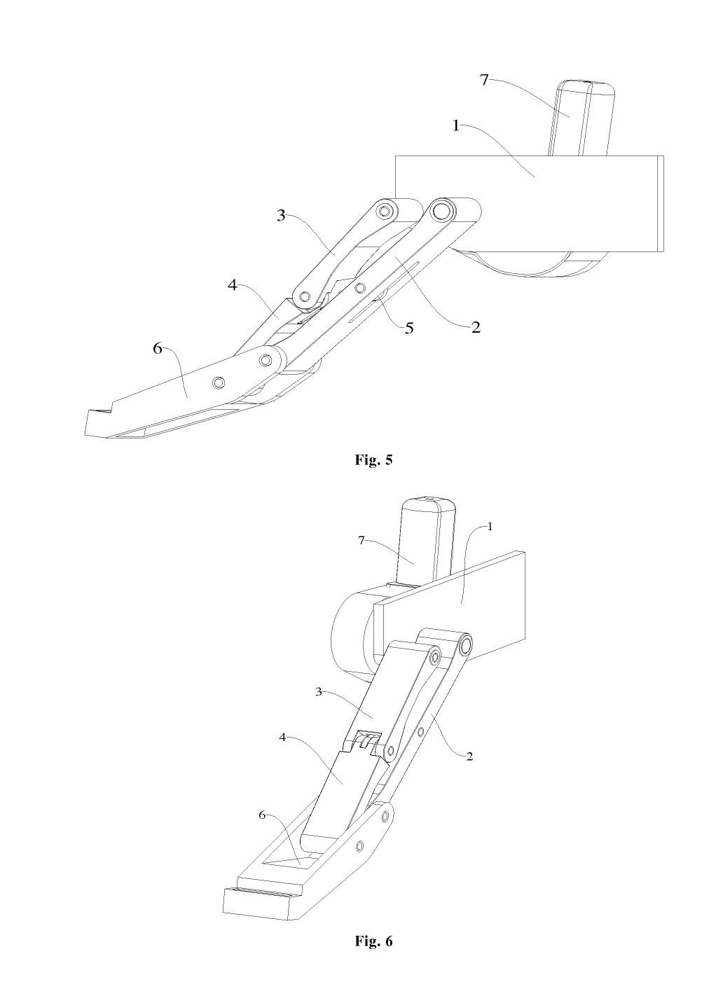

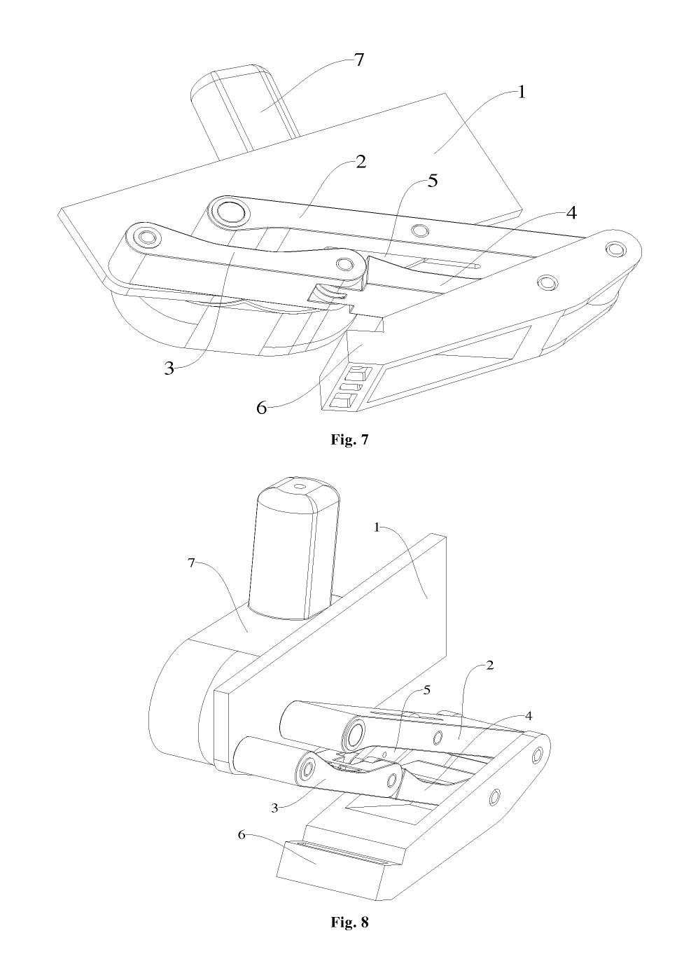

In the following, an extending and retracting device for a vehicle step apparatus according to embodiments of the present invention will be described with reference to the drawings. As shown in FIGS. 1-8, the extending and retracting device for the vehicle step apparatus according to the embodiments of the present invention includes a mounting bracket 1, a step bracket 6, a first arm 2, a second arm 3, a third arm 4, and a fourth arm 5.

The first end 2A of the first arm 2 is pivotally connected to the mounting bracket 1, and the second end 2B of the first arm 2 is pivotally connected to the step bracket 6. The first end 3A of the second arm 3 is pivotally connected to the mounting bracket 1. The first end 4A of the third arm 4 is pivotally connected to the second end 3B of the second arm 3, and the second end 4B of the third arm 4 is pivotally connected to the step bracket 6. The first end 5A of the fourth arm 5 is pivotally connected to the second end 3B of the second arm 3 and the first end 4A of the third arm 4, and the second end 5B of the fourth arm 5 is pivotally connected to the first arm 2.

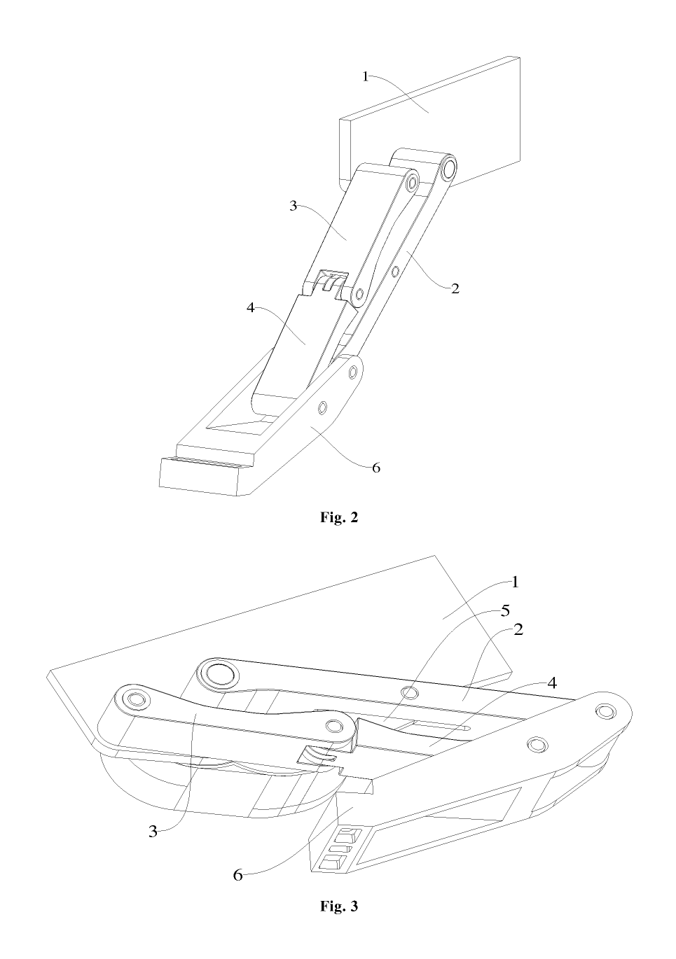

In the following, the movement of the extending and retracting device for the vehicle step apparatus according to embodiments of the present invention will be briefly described with reference to FIG. 1-8. As shown in FIGS. 2, 5, and 6, when the door of the vehicle is opened, the extending and retracting apparatus moves to an extended position such that a passenger can get on the vehicle via the step member 8. As shown in FIGS. 3, 7, and 8, when the door is closed, the extending and retracting apparatus moves to a retracted position. As shown in FIGS. 2, 3, and 5-8, the step bracket 6 of the extending and retracting device for the vehicle step apparatus has a long stroke.

The mounting bracket 1, along with the step bracket 6, the first arm 2, the second arm 3, the third arm 4, and the fourth arm 5, substantially forms a six-link mechanism which has improved stiffness and strength, in particular for a mechanism with a long link and stroke, compared with conventional four-link mechanisms and five-link mechanisms. In addition, the six-link mechanism effects greater freedom of movement, thereby eliminating interference such that the extending and retracting device can operate more stably and the life of the extending and retracting device can be increased.

According to the embodiments of the present invention, the extending and retracting device for the vehicle step apparatus substantially forms a six-link mechanism in that the first end 5A of the fourth arm 5 is pivotally connected with the second end 3B of the second arm 3 and the first end 4A of the third arm 4, and the second end 5B of the fourth arm 5 is pivotally connected with the first arm 2. Therefore, the extending and retracting device has increased stroke and application range with higher stiffness and strength, while the extending and retracting device is more stable in operation and prolonged in life.

In one embodiment, as shown in FIGS. 1-8, the extending and retracting device includes a mounting bracket 1, a step bracket 6, a first arm 2, a second arm 3, a third arm 4, and a fourth arm 5. The mounting bracket 1 is adapted to be mounted on the chassis of a vehicle, and the step bracket 6 is provided with a step member 8 thereon. The first arm 2, the second arm 3, the third arm 4, and the fourth arm 5 can be in the form of a plate.

The first end 2A and the second end 2B of the first arm 2 in a longitudinal direction (i.e. the length direction of the first arm 2) are pivotally connected to the mounting bracket 1 and the step bracket 6 respectively.

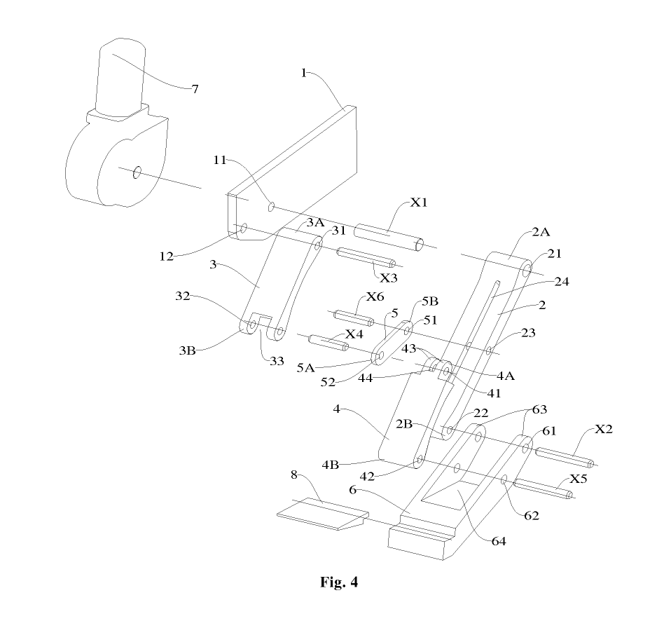

As shown in FIGS. 1 and 4, the first end 2A (i.e. the upper end shown in FIGS. 1 and 4) of the first arm 2 is pivotally connected to the mounting bracket 1 via a first pivot X1, and the second end 2B (i.e. the lower end in FIGS. 1 and 4) of the first arm 2 is pivotally connected to the step bracket 6 via a second pivot X2.

The first pivot X1 passes through a first hole 11 in the mounting bracket 1 and a third hole 21 in the first end 2A of the first arm 2, thereby pivotally connecting the upper end of the first arm 2 with the mounting bracket 1. The second pivot X2 passes through a fourth hole 22 in the second end 2B of the first arm 2 and a twelfth hole 61 in the step bracket 6, thereby pivotally connecting the second end 2B of the first arm 2 with the step bracket 6.

The first end 3A (i.e. the upper end in FIGS. 1 and 4) of the second arm 3 is pivotally connected to the mounting bracket 1 via a third pivot X3, and the second end 3B (i.e. the lower end in FIGS. 1 and 4) of the second arm 3 is pivotally connected to the first end 4A (i.e. the upper end in FIGS. 1 and 4) of the third arm 4 and the first end 5A of the fourth arm 5 via a fourth pivot X4.

The third pivot X3 passes through a second hole 12 in the mounting bracket 1 and a sixth hole 31 in the upper end of the second arm 3, thereby pivotally connecting the upper end of the second arm 3 with the mounting bracket 1. The fourth pivot X4 sequentially passes through a seventh hole 32 in the second end 3B of the second arm 3, an eighth hole 41 in the first end 4A of the third arm 4, and an eleventh hole 52 in the first end 5A of the fourth arm 5, thereby pivotally connecting the second arm 3, the third arm 4 and the fourth arm 5.

As shown in FIGS. 1 and 4, in one embodiment, the second end 3B of the second arm 3 has a U-shaped second arm groove 33, and the first end 4A of the third arm 4 has a protrusion adapted to be fitted within the second arm groove 33. Thus, the protrusion of the third arm 4 is fitted within the second arm groove 33 of the second arm 3, the eighth hole 41 is formed in the protrusion and the fourth pivot X4 passes through the protrusion.

As shown in FIGS. 1 and 4, the protrusion of the third arm 4 includes two lugs 43 spaced apart from each other, and the first end 5A of the fourth arm 5 is fitted between the two lugs 43. Thus, there is a third arm groove 44 between the two lugs 43 spaced apart from each other, with the first end 5A of the fourth arm 5 contained in the third arm groove 44 and the eighth hole 41 running through the two lugs 43.

The second end 4B (i.e. the lower end in FIGS. 1 and 4) of the third arm 4 is pivotally connected to the step bracket 6 via a fifth pivot X5. More specifically, the fifth pivot X5 passes through a ninth hole 42 in the second end 4B of the third arm 4 and a thirteenth hole 62 in the step bracket 6, thereby pivotally connecting the lower end of the third arm 4 with the step bracket 6. The step bracket 6 has a bracket groove 64, and the second end 2B of the first arm 2 and the second end 4B of the third arm 4 are fitted within the bracket groove 64. The step bracket 6 includes two side walls 63 spaced apart from each other, between which the bracket groove 64 is formed. Each side wall 63 is provided with the twelfth hole 61 and the thirteenth hole 62.

The second end 5B of the fourth arm 5 is connected to the first arm 2 via a sixth pivot X6. More specifically, the six pivot X6 passes through a tenth hole 51 in the second end 5B of the fourth arm 5 and a fifth hole 23 in the first arm 2, thus pivotally connecting the second end 5B of the fourth arm 5 with the first arm 2.

In one embodiment, the second end 5B of the fourth arm 5 is connected with the middle portion of the first arm 2, such that the extending and retracting device is structurally stable under balanced forces and, thus, does not easily deform. To that end, the fifth hole 23 is formed in the middle portion of the first arm 2.

As shown in FIGS. 3, 5, 7, and 8, the first arm 2 is provided with a first arm groove 24, and the second end 5B of the fourth arm 5 is fitted within the first arm groove 24. In one embodiment, the second arm 3 is substantially coaxial with the third arm 4, and the first arm 2 is substantially parallel to the second arm 3 and the third arm 4.

In the following, the vehicle step apparatus according to embodiments of the present invention will be described. As shown in FIGS. 4-8, the vehicle step apparatus according to the embodiments of the present invention includes an extending and retracting device, a step member 8, and a drive device. The extending and retracting device can be the extending and retracting device according to the embodiments of the present invention described above, whereby and the step member 8 is mounted on the step bracket 6 of the extending and retracting device. The drive device drives at least one of the first arm 2 and the second arm 3 to drive the extending and retracting device to move the step member 8 between the extended position and the retracted position.

By being provided with the extending and retracting device, the vehicle step apparatus of the present invention provides greater stroke, a wider application range, higher stiffness and strength, and more stable operation with longer life.

The drive device can drive at least one of the first arm 2 and the second arm 3 (for example, the first arm 2) via a decelerator, so as to drive the extending and retracting device to move the step member 8 between the extended position and the retracted position. In one embodiment, the drive device may be a drive motor 7. Those having ordinary skill in the art will appreciate that the drive motor 7 may drive the first arm 2 via the decelerator.

In the embodiment shown in FIG. 4, the vehicle step apparatus has one extending and retracting device. However, those having ordinary skill in the art will appreciate that both longitudinal ends of the step member 8 may be each provided with one extending and retracting device.

In the description of the present invention, terms such as “first,” “second,” “longitudinal,” “lateral,” “upper,” “lower,” “extending” and “retracting” refer to the orientation or position as shown in the drawings under discussion. These relative terms are for convenience of description and do not require that the present invention must be constructed and operated in a particular orientation and, thus, are not to be construed to limit the present invention.

In addition, terms such as “first” and “second” are used herein for purposes of description and are not intended to indicate or imply relative importance or significance or to imply the number of indicated technical features. Thus, a feature defined with “first” and “second” may explicitly or implicitly include one or more feature. In the description of the present invention, “a plurality of” refers to at least two (such as two, three or the like), unless specified otherwise.

In the present invention, unless specified or limited otherwise, the terms “mounted,” “connected,” “coupled,” “fixed” and the like are used broadly, and may be, for example: fixed connections, detachable connections, or integral connections; mechanical connections, electrical connections, or in communication with each other; direct connections or indirect connections via intervening structures; inner communications or interaction of two elements, which can be understood by those skilled in the art according to specific situations.

In the present invention, unless specified or limited otherwise, a structure in which a first feature is “on” or “below” a second feature may include an embodiment in which the first feature is in direct contact with the second feature, and may also include an embodiment in which the first feature and the second feature are in indirect contact with each other via intervening structures. Furthermore, a first feature “on,” “above” or “on top of” a second feature may include an embodiment in which the first feature is right or obliquely “on,” “above” or “on top of” the second feature, or may indicate that the first feature is at a height higher than that of the second feature; while a first feature “below,” “under” or “on bottom of” a second feature may include an embodiment in which the first feature is right or obliquely “below,” “under” or “on bottom of” the second feature, or may indicate that the first feature is at a height lower than that of the second feature.

Reference throughout this specification to “an embodiment,” “some embodiments,” “examples,” “specific examples,” or “some examples” indicates that a particular feature, structure, material, or characteristic described in connection with the embodiment or example is included in at least one embodiment or example of the present invention. Thus, these terms throughout the specification do not necessarily refer to the same embodiment or example. Furthermore, the particular features, structures, materials, or characteristics may be combined in any suitable manner in one or more embodiments or examples. In addition, those having ordinary skill in the art can combine different embodiments or examples and the features thereof described in the specification when they are not in conflict.

Although embodiments of the present invention have been shown and described, it will be appreciated by those having ordinary skill in the art that the above embodiments cannot be construed to limit the present invention, and changes, modifications, alternatives and variations can be made in the embodiments without departing from the scope of the present invention.

What is claimed is:

1. An extending and retracting device for a vehicle step apparatus, comprising:
a mounting bracket;
a step bracket;
a first arm defining a first end pivotally connected to the mounting bracket and a second end pivotally connected to the step bracket;
a second arm defining a first end pivotally connected to the mounting bracket and a second end;
a third arm defining a first end pivotally connected to the second end of the second arm and a second end pivotally connected to the step bracket; and
a fourth arm defining a first end pivotally connected to the second end of the second arm and the first end of the third arm respectively, and a second end pivotally connected to the first arm.

2. The extending and retracting device as set forth in claim 1, wherein the second arm is substantially coaxial with the third arm, and the first arm is substantially parallel to the second and third arms.

3. The extending and retracting device as set forth in claim 1, wherein the second end of the fourth arm is connected with a middle portion of the first arm.

4. The extending and retracting device as set forth in claim 1, wherein the first to fourth arms are in a form of a plate.

5. The extending and retracting device as set forth in claim 1, wherein the first end of the first arm is connected to the mounting bracket via a first pivot, and the second end of the first arm is connected to the step bracket via a second pivot;
the first end of the second arm is connected to the mounting bracket via a third pivot;
the second end of the second arm and the first end of the third arm are connected to the first end of the fourth arm via a fourth pivot;
the second end of the third arm is connected to the step bracket via a fifth pivot; and
the second end of the fourth arm is connected to the first arm via a sixth pivot.

6. The extending and retracting device as set forth in claim 1, wherein the second end of the second arm has a U-shaped second arm groove, and the first end of the third arm has a protrusion adapted to be fitted within the second arm groove.

7. The extending and retracting device as set forth in claim 6, wherein the protrusion includes two lugs spaced apart from each other, and the first end of the fourth arm is fitted between the two lugs.

8. The extending and retracting device as set forth in claim 1, wherein the first arm is provided with a first arm groove, and the second end of the fourth arm is fitted within the first arm groove.

9. The extending and retracting device as set forth in claim 1, wherein the step bracket has a bracket groove, and the second end of the first arm and the second end of the third arm are fitted within the bracket groove.

10. A vehicle step apparatus, comprising:
an extending and retracting device which includes:
a mounting bracket;
a step bracket;
a first arm defining a first end pivotally connected to the mounting bracket and a second end pivotally connected to the step bracket;
a second arm defining a first end pivotally connected to the mounting bracket and a second end;
a third arm defining a first end pivotally connected to the second end of the second arm and a second end pivotally connected to the step bracket;
a fourth arm defining a first end pivotally connected to the second end of the second arm and the first end of the third arm respectively, and a second end pivotally connected to the first arm;
a step member mounted on the step bracket of the extending and retracting device; and
a drive device driving at least one of the first and second arms to drive the extending and retracting device to move the step member between an extended position and a retracted position.

11. The vehicle step apparatus as set forth in claim 10, wherein the second arm is substantially coaxial with the third arm, and the first arm is substantially parallel to the second and third arms.

12. The vehicle step apparatus as set forth in claim 10, wherein the second end of the fourth arm is connected with a middle portion of the first arm.

13. The vehicle step apparatus as set forth in claim 10, wherein the first to fourth arms are in a form of a plate.

14. The vehicle step apparatus as set forth in claim 10, wherein the first end of the first arm is connected to the mounting bracket via a first pivot, and the second end of the first arm is connected to the step bracket via a second pivot;
the first end of the second arm is connected to the mounting bracket via a third pivot;
the second end of the second arm and the first end of the third arm are connected to the first end of the fourth arm via a fourth pivot;
the second end of the third arm is connected to the step bracket via a fifth pivot; and
the second end of the fourth arm is connected to the first arm via a sixth pivot.

15. The vehicle step apparatus as set forth in claim 10, wherein the second end of the second arm has a U-shaped second arm groove, and the first end of the third arm has a protrusion adapted to be fitted within the second arm groove.

16. The vehicle step apparatus as set forth in claim 15, wherein the protrusion includes two lugs spaced apart from each other, and the first end of the fourth arm is fitted between the two lugs.

17. The vehicle step apparatus as set forth in claim 10, wherein the first arm is provided with a first arm groove, and the second end of the fourth arm is fitted within the first arm groove.

18. The vehicle step apparatus as set forth in claim 10, wherein the step bracket has a bracket groove, and the second end of the first arm and the second end of the third arm are fitted within the bracket groove.
